(19) United States
(12) Patent Application Publication
(10) Pub. No.: US 2005/0067884 A1
(43) Pub. Date: Mar. 31, 2005

(54) Brake balance system for tandem axles

(76) Inventor: James R. Clark, Plainwell, MI (US)

Correspondence Address: Attn: Stephen P. Evans, Esq;Marshall & Melhorn, LLC, 8th Floor, Four SeaGate, Toledo, OH, 43604, US

(21) Appl. No.: 10/670,937

(22) Filed: Sep. 25, 2003

(51) Int. Cl. B60T 13/00

(52) U.S. Cl. 303/9.62

(57) ABSTRACT

A tandem axle system has a first brake axle and at least a second brake axle. The first axle has a first brake actuating chamber with a first diaphragm and the second axle has a second brake actuating chamber with a second diaphragm. The first axle also has a first brake actuating arm and the second axle has a second brake actuating arm. The size of the second diaphragm can be reduced as compared to the first diaphragm and/or the length of the second brake actuating arm can be reduced as compared to the first brake actuating arm to reduce the braking force applied to the second axle.

### FIELD OF THE INVENTION

The present invention relates to a method and apparatus for controlling the braking of tandem axle vehicle systems.

### BACKGROUND OF THE INVENTION

Heavy trucks with tandem axles often experience greater wear on the brakes of the rearmost axle. The greater wear can be attributed to higher brake temperatures since the preceding axle blocks a significant portion of the oncoming cooling air. The additional wear can also be attributed to the application of the same braking force to the higher temperature rearmost axle as applied to a preceding axle.

Examples of known brake control systems developed to reduce wear on brakes can be found in, for example, U.S. Pat. No. 5,470,134, which provides for a method of determining wear-dependent braking force distribution between the braked wheels of a vehicle. The method includes determining the wear values of the brake linings of a vehicle and sending the values to a computer. The computer determines the distribution of braking force for each brake based upon the wear values.

U.S. Pat. Nos. 4,804,237 and 4,804,234 disclose a control unit for receiving signals from sensors regarding horizontal and vertical forces experienced by a tractor. Sensors also measure the acceleration of the tractor, and the demand for braking by the tractor operator. The sensed acceleration and the sensed demand for braking are provided to the control unit. The control unit processes the signals and issues outputs to actuators to modulate the braking effort between the tractor and a trailer.

U.S. Pat. No. 5,172,960 provides for a brake control for minimizing the number of brakes activated and optimizing the wear conditions. A driver engages a brake pedal which produces a signal to a computer. The computer calculates the minimum number of braking devices to be activated to obtain the desired deceleration.

U.S. Pat. No. 5,312,168 provides for a method and apparatus for equalizing vehicle brake wear. Brake wear between braking sites of a vehicle is equalized by measuring work performed at the braking sites. The work at each site is compared with an average calculated work for all the braking sites. Brake demand is increased at any braking site determined to be performing less than the average amount of work.

U.S. Pat. No. 5,403,072 teaches a brake-pressure control device having wear sensors on the brake linings. Output signals from the sensors are fed to a computer. In the event that the computer determines differing wear on the linings, it generates a signal to a solenoid valve which modifies the brake pressure on the brakes with the thicker lining.

U.S. Pat. No. 4,768,840 provides for a brake control system that senses the magnitude of the vehicle operator's braking request and then distributes the braking effort between the individually controllable brakes.

Those skilled in the art recognize that the above-described prior art tandem axle braking systems can be improved. Specifically, it is desirable to improve brake and axle life, simply maintenance of both, reduce wear on the brakes of the rearmost axle and to accomplish the foregoing without expensive and complicated controllers.

### SUMMARY OF THE INVENTION

In one embodiment of the invention, a first axle has a first brake actuating chamber. The first brake actuating chamber has a first diaphragm with a pre-determined area. The first diaphragm is connected to a first brake actuating arm for engaging a first friction device on the first axle. A second axle, typically located behind the first axle, has a second brake actuating chamber. The second brake actuating chamber has a second diaphragm also with a pre-determined area. The area of the second diaphragm is less than the area of the first diaphragm. The second diaphragm is connected to a second brake actuating arm for engaging a second friction device on the second axle.

The first and second diaphragms displace the first and second actuating arms which engage the first and second friction devices on the first and second axles, respectively. The smaller second diaphragm does not displace the second actuating arm to the extent that the first diaphragm displaces the first actuating arm. The smaller displacement of the second actuating arm results in less braking force to the second friction device than the braking force provided by the first friction device.

Another embodiment of the present invention includes the above-described components, however, the first and second diaphragms are substantially equal in area. In this embodiment, the second brake actuating arm is shorter than the first brake actuating arm. The shorter second brake actuating arm provides a smaller force to the second friction device than provided by the first brake actuating arm to the first friction device.

In yet another embodiment of the presenting invention, a second diaphragm smaller than the first is used and a second brake actuating arm shorter than the first is used. The smaller second diaphragm and the shorter second brake actuating arm result in a smaller braking force on the second axle than the braking force for the first axle.

By using any of the above-described embodiments, the wear on the brakes of a vehicle rearmost axle can be improved over the above-described systems without expensive and complicated controllers. It has been found that the present invention balances the temperature and wear experienced by the rearmost axle while simultaneously simplifying brake and axle maintenance. It has also been found that the method and apparatus of the present invention results in increased brake and axle life.

The present invention can also improve vehicle stopping distance as compared to the known prior art devices. Suspensions on tandem axles are known to articulate during braking such that one axle takes on more loading, while the other axle takes on less loading. Through the present invention, the brakes on the axle with more loading can produce more braking force, thus stopping the vehicle in a shorter distance.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a schematic side view of an embodiment of the present invention;

FIG. 2 is a schematic side view of another embodiment of the present invention;

FIG. 3 is a schematic side view of another embodiment of the invention depicted in FIG. 1;

FIG. 4 is a schematic side view of another embodiment of invention depicted in FIG. 2;

FIG. 5 is a schematic side view of another embodiment of the invention depicted in FIG. 1; and

FIG. 6 is a schematic side view of another embodiment of the invention depicted in FIG. 2.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics related to the embodiments disclosed are not to be considered at limiting, unless the claims expressly state otherwise.

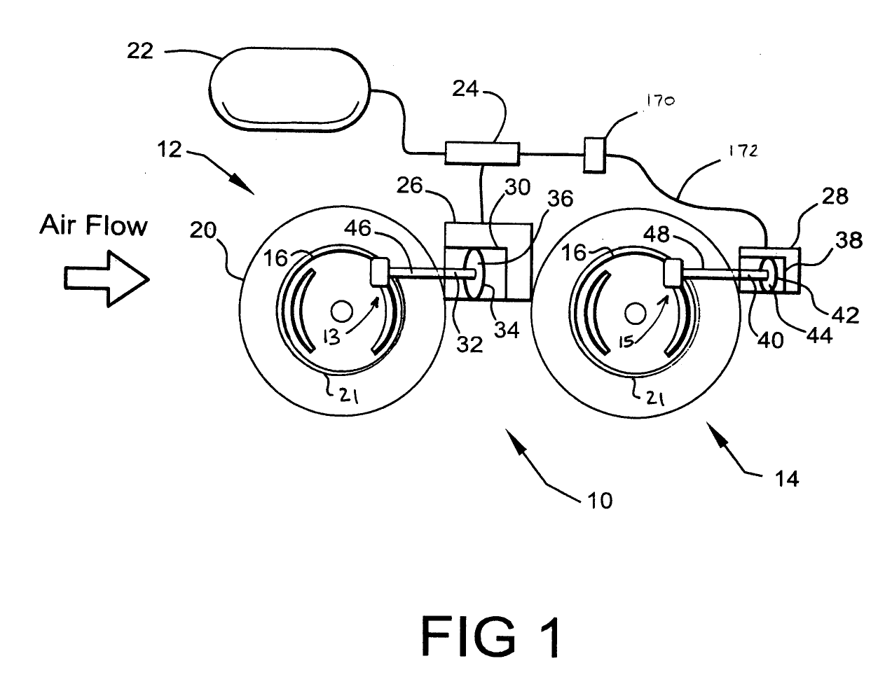

Referring now to FIGS. 1-6, a tandem axle 10 for a vehicle (not shown) is depicted. The tandem axle 10 may be such as that for a tractor and/or the axle 10 may be such as that for a trailer pulled by a tractor as known by those skilled in the art. The tandem axle 10 of the present invention is not limited to tractor/trailer combinations, but may be used for any vehicle using one axle located behind another. Further, those skilled in the art will readily appreciate that the inventive concepts herein can be used with axle systems having more than two axles.

For purposes of clarity, the left hand axle depicted in the figures will be designated the first axle 12, and the right hand axle will be designated the second axle 14. The direction of airflow with respect to the axles is from the left to the right of the page in the figures.

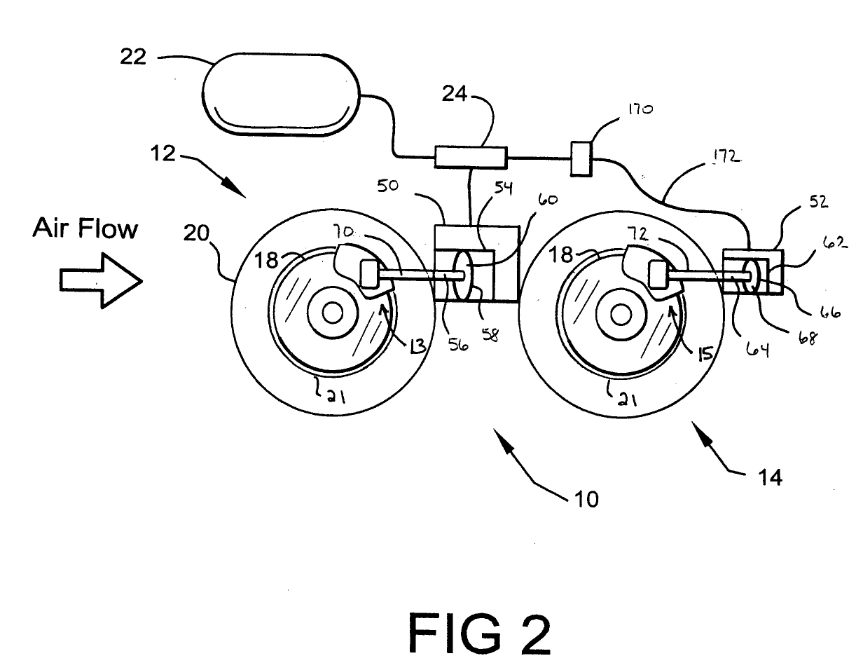

Both the first 12 and the second 14 axles are standard axles known to those skilled in the art. Each axle 12, 14 has, among other components, a drum 16 (FIGS. 1, 3, 5) and/or a disc 18 (FIGS. 2, 4, 6) and an associated tire 20 mounted on a wheel 21. The axles 12, 14 may be steerable or non-steerable, and/or driven or non-driven.

Those skilled in the art will appreciate that friction devices, or brakes, are commonly associated with tandem axles to slow the rotation of the drum 16 and/or disc 18, associated tire 20 and wheel 21 and hence the vehicle. Fluid driven brakes, such as pneumatic or hydraulic, and their systems are well known in the art. For the purpose of clarity, a pneumatic brake system will be described herein, although other fluid and/or mechanical brake systems known to those skilled in the art can also use the present invention.

One type of friction device, known to those skilled in the art as drum brakes, is depicted in FIGS. 1, 3, 5, and used to apply a retarding, frictional force to the rotating drum 16. Another type of friction device, known to those skilled in the art as disc brakes, is depicted in FIGS. 2, 4, 6, and used to apply a retarding, frictional force to a rotating disc 18. Drum and disc brakes are described herein as a preferred embodiment of the present invention, however, other brakes known to those skilled in the art are also within the scope of the invention. Preferably, the first axle 12 has a first friction device 13 connected therewith and the second axle 14 has a second friction device 15 connected therewith.

A component of a fluid driven brake system includes at least one fluid pressurization means. Typically, the fluid pressurization means is an engine driven air compressor 22. A combination of electronic and/or mechanical controllers, governors, check valves, safety valves, reservoirs, sensors, switches, fluid lines and at least one driver operated brake pedal, among other components known to those skilled in the art, have a fluid connection with the compressor 22 and make up a standard pneumatic brake system.

The compressor 22, typically through the above-mentioned combination, provides compressed air to at least one air control valve 24. The air control valve 24 can be in communication with one drum/wheels combination on an end of an axle, all of the drums/wheels on an axle or with all of the drums/wheels on one or more axles. The air control valve 24 can also be in communication with one disc/wheel combination or an end of an axle, all of the discs/wheels on an axle or with all of the discs/wheels on one or more axles.

In the present invention, the at least one air control valve 24 is in fluid communication with a first brake actuating chamber 26 and a second brake actuating chamber 28 as depicted in FIG. 1. The first brake actuating chamber 26 has a first pressure housing 30, a first pushrod 32 and a first diaphragm 34 having a first area 36. The second brake actuating chamber 28 has a second pressure housing 38, a second pushrod 40 and a second diaphragm 42 having a second area 44.

In a preferred embodiment of the invention, the second area 44 is less than the first area 36. Those skilled in the art will recognize that a standard diaphragm area is between approximately 16 and approximately 36 square inches. An example of a preferred embodiment is the first diaphragm 34 having a first area 36 of approximately 30 square inches and the second diaphragm 42 having a second area 44 of approximately 24 square inches.

Application of air pressure to the first brake actuating chamber 26 extends the first diaphragm 34 therein, which in turn displaces the first pushrod 32 connected thereto. Similarly, application of air pressure to the second brake actuating chamber 28 extends the second diaphragm 42 therein, which in turn displaces the second pushrod 40 connected thereto.

The smaller second area 44 of the second diaphragm 42 does not deflect to the extent of the first diaphragm 34, thus the pushrod 40 of the second diaphragm 42 is not displaced as great a distance as the push rod 32 of the first diaphragm 34. Those skilled in the art understand that a force exerted on a pushrod is the product of the air pressure applied to a diaphragm and the area of the diaphragm. The smaller, second diaphragm 42, therefore, exerts less force on the second pushrod 40 than the larger, first diaphragm 34 exerts on the first pushrod 32 when the applied air pressures are equal.

The first pushrod 32 is connected to a first brake actuating arm 46. Similarly, the second pushrod 40 is connected to a second brake actuating arm 48. The first and second brake actuating arms 46, 48 are force multipliers that multiply a force in proportion to their length. By way of example only, a four inch long brake actuating arm converts 1000 pounds of force at the pushrod to 4000 inch-pounds at the opposite end. The invention depicted in FIG. 1 has first 46 and second 48 brake actuating arms with substantially equal lengths.

In FIG. 2, the at least one air control valve 24 is in fluid communication with a first brake actuating chamber 50 and a second brake actuating chamber 52. The first brake actuating chamber 50 has a first pressure housing 54, a first pushrod 56 and a first diaphragm 58 having a first area 60. The second brake actuating chamber 52 has a second pressure housing 62, a second pushrod 64 and a second diaphragm 66 having a second area 68.

In a preferred embodiment of the invention, the second area 68 is less than the first area 60. Those skilled in the art will recognize that a standard diaphragm area is between approximately 16 and approximately 36 square inches. An example of a preferred embodiment is the first diaphragm 58 having a first area 60 of approximately 30 square inches and the second diaphragm 66 having a second area 68 of approximately 24 square inches.

Application of air pressure to the first brake actuating chamber 50 extends the first diaphragm 58 therein, which in turn displaces the first pushrod 56 connected thereto. Similarly, application of air pressure to the second brake actuating chamber 52 extends the second diaphragm 66 therein, which in turn displaces the second pushrod 64 connected thereto.

The smaller second area 68 of the second diaphragm 66 does not deflect to the extent of the first diaphragm 58, thus the pushrod 64 of the second diaphragm 66 is not displaced as great a distance as the push rod 56 of the first diaphragm 58. Those skilled in the art understand that a force exerted on a pushrod is the product of the air pressure applied to a diaphragm and the area of the diaphragm. The smaller, second diaphragm 66, therefore, exerts less force on the second pushrod 64 than the larger, first diaphragm 58 exerts on the first pushrod 56 when the applied air pressures are equal.

The first pushrod 56 is connected to a first brake actuating arm 70. Similarly, the second pushrod 64 is connected to a second brake actuating arm 72. The first and second brake actuating arms 70, 72 are force multipliers that multiply a force in proportion to their length. By way of example only, a four inch long brake actuating arm converts 1000 pounds of force at the pushrod to 4000 inch-pounds at the opposite end. The invention depicted in FIG. 2 has first 70 and second 72 brake actuating arms with substantially equal lengths.

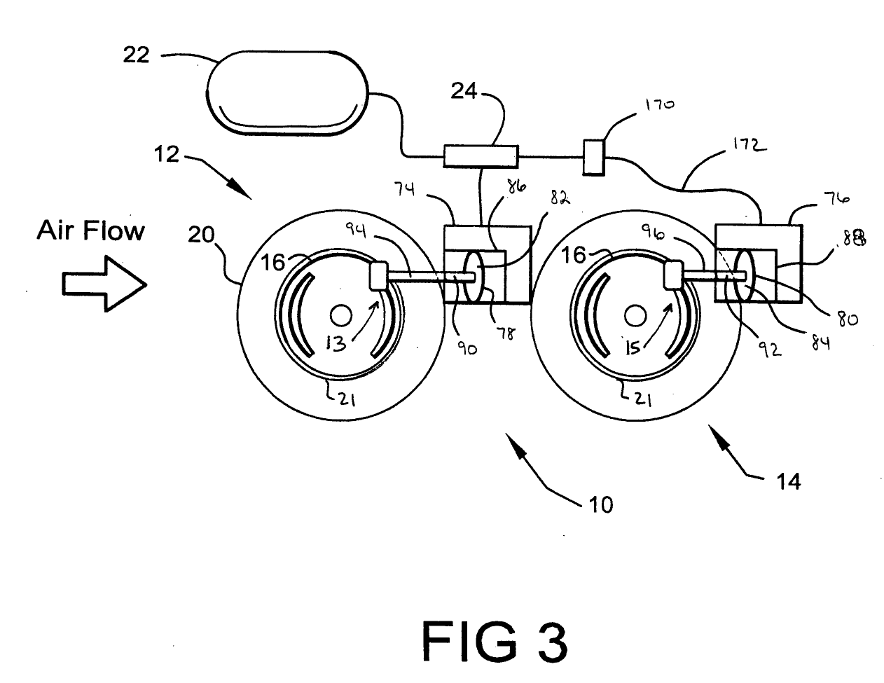

The alternative embodiment of the present invention depicted in FIG. 3 uses identical reference numbers to identify like components described above. FIG. 3 depicts an alternative embodiment related to drum brakes. The invention depicted in FIG. 3 differs from the previous embodiments since it has first and second actuating chambers 74, 76 having diaphragms 78, 80 of substantially equal area 82, 84. The diaphragms 78, 80 are housed in pressure housings 86, 88. First and second pushrods 90, 92 connect the diaphragms 78, 80 with first and second brake actuating arms 94, 96. In this embodiment, the first and second brake actuating arms 94, 96 are of unequal length.

In a preferred embodiment, the first brake actuating arm 94 is longer than the second brake actuating arm 96. The length of brake actuating arms 94, 96 varies from approximately 3 inches to approximately 8 inches. An example of a preferred embodiment of the present invention uses a first brake actuating arm 94 having a length of approximately 6 inches and a second brake actuating arm 96 having a length of approximately 5.5 inches.

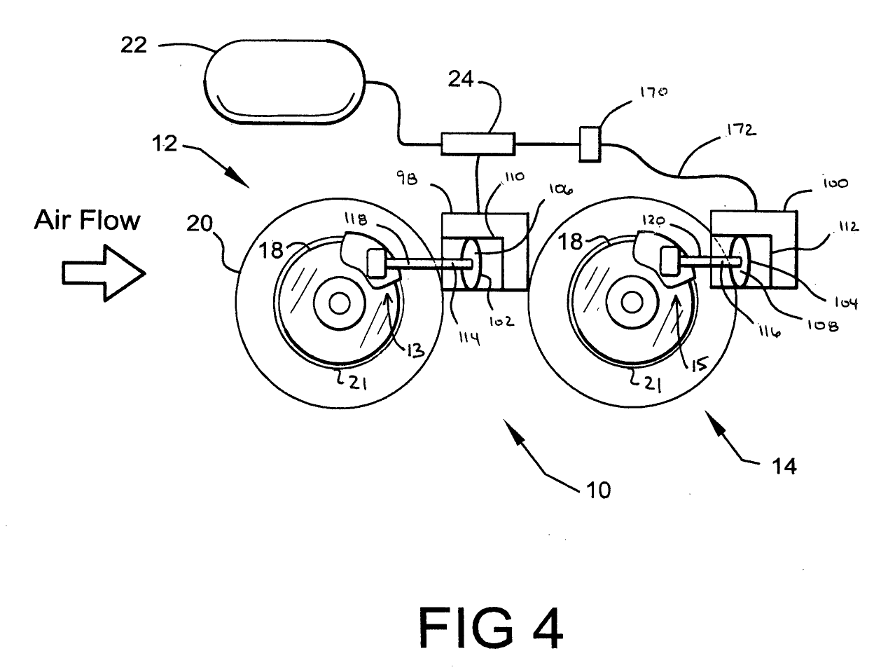

The alternative embodiment of the present invention depicted in FIG. 4 uses identical reference numbers to identify like components described above. FIG. 4 depicts an alternative embodiment related to disc brakes.

The invention depicted in FIG. 4 differs from the previous embodiments since it has first and second actuating chambers 98, 100 having diaphragms 102, 104 of substantially equal area 106, 108. The diaphragms 102, 104 are housed in pressure housings 110, 112. First and second pushrods 114, 116 connect the diaphragms 102, 104 with first and second brake actuating arms 118, 120. In this embodiment, the first and second brake actuating arms 118, 120 are of unequal length.

In a preferred embodiment, the first brake actuating arm 118 is longer than the second brake actuating arm 120. The length of brake actuating arms 118, 120 varies from approximately 3 inches to approximately 8 inches. An example of a preferred embodiment of the present invention uses a first brake actuating arm 118 having a length of approximately 6 inches and a second brake actuating arm 120 having a length of approximately 5.5 inches.

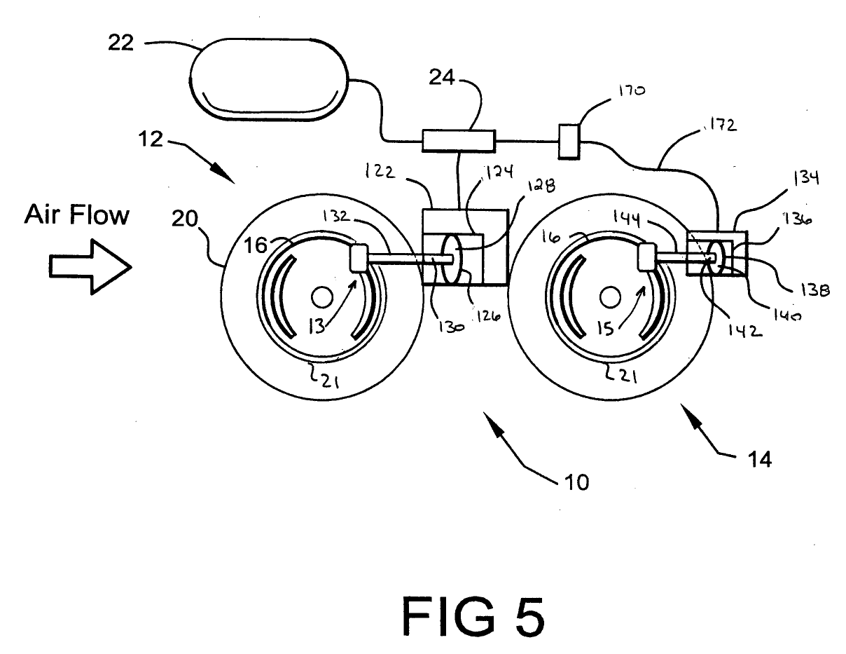

Another embodiment of the present invention is depicted in FIG. 5 where identical reference numbers have been used to identify like components described above. FIG. 5 depicts an alternative embodiment related to brake drums. In this embodiment, the first axle has a first brake actuating chamber 122 enclosing a first pressure housing 124. A first diaphragm 126 is located within the first pressure housing 124 having an area 128. A first pushrod 130 is connected to the first diaphragm 126. A first brake actuating arm 132 is connected to the first pushrod 130.

The second axle 14 has a second brake actuating chamber 134 enclosing a second pressure housing 136. A second diaphragm 138 is located within the second pressure housing 136 having an area 140. A second pushrod 142 is connected to the second diaphragm 138. A second brake actuating arm 144 is connected to the second pushrod 142.

Preferably, the area 140 of the second diaphragm 138 is less than the area 128 of the first diaphragm 126. Additionally, the second brake actuating arm 144 is shorter than the first brake actuating arm 132.

Those skilled in the art will appreciate that the brake actuating arms 46, 48, 94, 96, 132, 144 for the drum brakes described above may be connected to a first end of a rotatable cam shaft (not shown). Proximate the second end of the cam shaft, an S-shaped cam is provided. Although an S-shaped cam is referred to, it is only one embodiment and those skilled in the art will readily appreciate that other mechanisms having an equivalent function to the S-shaped cam are well within the scope of the present invention.

The S-shaped cam is located between two brake shoes of the brake drum. Rotation of the shaft rotates the cam which forces the brake shoes apart. The brake shoes are forced into the brake drum, creating the friction needed to slow the vehicle.

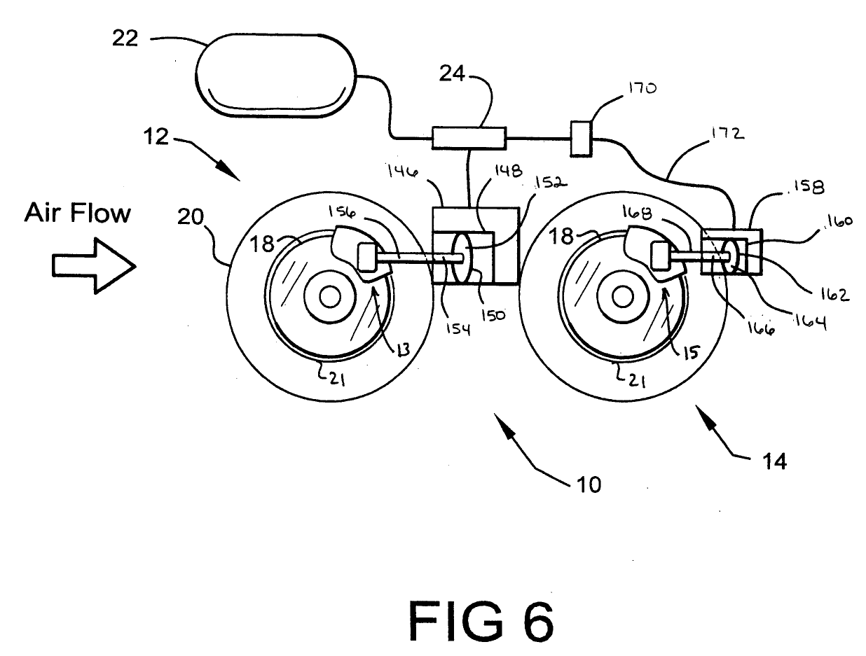

FIG. 6 depicts an alternative embodiment related to disc brakes. In this embodiment, the first axle 12 has a first brake actuating chamber 146 enclosing a first pressure housing 148. A first diaphragm 150 is located within the first pressure housing 148 having an area 152. A first pushrod 154 is connected to the first diaphragm 150. A first brake actuating arm 156 is connected to the first pushrod 154.

The second axle 14 has a second brake actuating chamber 158 enclosing a second pressure housing 160. A second diaphragm 162 is located within the second pressure housing 160 having an area 164. A second pushrod 166 is connected to the second diaphragm 162. A second brake actuating arm 168 is connected to the second pushrod 166.

Preferably, the area 164 of the second diaphragm 162 is less than the area 152 of the first diaphragm 150. Additionally, the second brake actuating arm 168 is shorter than the first brake actuating arm 156.

In the embodiment where a disc is used, those skilled in the art will appreciate that the brake actuating arm 70, 72, 118, 120, 156, 168 may be connected to an actuator assembly (not shown). The brake actuating arm engages the actuator assembly which causes one or more brake pads to frictionally engage the rotor disc.

Regardless of whether a drum 16 or disc 18 is disclosed, it is well known that the amount of friction produced is determined, in part, by the size of the brakes, the coefficient of friction of the brake lining material, the mass of the drum or disc and the heat rejecting potential of the drum or disc.

As depicted in FIGS. 1-6, a second air control valve 170 may be located in a fluid pressure line 172 leading to the second brake actuating chamber 28, 52, 76, 100, 134, 158. The second air control valve 170 decreases the fluid pressure to the second brake actuating chamber 28, 52, 76, 100, 134, 158. The second air control valve 170 can be the sole source of the decrease in the fluid pressure, or it can act in combination with the first air control valve 24 to decrease the fluid pressure.

A preferred method of using the invention depicted in FIGS. 1 and 2 will now be described. The vehicle operator engages a brake pedal signaling the air control valve 24 to open. The air control valve 24 opens and permits pressurized fluid, such as air, to simultaneously communicate with the first and the second brake actuating chambers 26, 28, 50, 52. The fluid pressure enters the chambers 26, 28, 50, 52 and causes the respective diaphragms 34, 42, 58, 66 to deform.

The second diaphragm 42, 66 has a smaller area 44, 68 than the first diaphragm 34, 58 and does not experience deformation as great as that of the first diaphragm 34, 58 nor does it produce as much force. The second diaphragm 42, 66 actuates the second brake actuating arm 48, 72 a pre-determined distance. The second brake actuating arm 48, 72 engages the second friction device 15 on the axle 14 to brake the wheel drum 16 or disc 18.

The first diaphragm 34, 58 similarly actuates the first brake actuating arm 46, 70 a pre-determined distance which is greater than the distance of the second brake actuating arm 48, 72. Thus, the first brake actuating arm 46, 70 engages the first friction device 13 to a greater extent than the second friction device 15 was engaged, and with a greater force. This results in the first friction device 13 braking its respective drum 16 and/or disc 18 to a greater extent that the second friction device 15 brakes its drum 16 and/or disc 18. The reduced braking force of the second friction device 15 keeps the friction device 15, including drum 16 and/or disc 18, at a lower temperature than that of the first friction device 13, including drum 16 and/or disc 18. The first friction device 13 can dissipate the additional heat more efficiently than the second friction device 15 due to the increased airflow about the first axle 12.

In the method of using the second embodiment of the invention depicted in FIGS. 3 and 4, the vehicle operator engages a brake pedal signaling the air control valve 24 to open. The air control valve 24 opens and permits pressurized fluid, such as air, to simultaneously communicate with the first 74, 98 and the second 76, 100 brake actuating chambers. The fluid pressure enters the chambers 74, 98, 76, 100 and causes the respective diaphragms 78, 80, 102, 104 to deform.

The first 78, 80 and second 102, 104 diaphragms deform substantially equally. The longer second brake actuating arm 96, 120, however, generates a larger force at the rotatable cam shaft than the shorter first brake actuating arm 94, 118. This larger force is transmitted to the first friction device 13 on the first axle 12 resulting in comparatively greater braking than provided by the smaller force applied to the second friction device 15.

In the method of using the third embodiment of the present invention depicted in FIGS. 5 and 6, the above-described shorter second brake actuating arm 144, 168 and the smaller second diaphragm 138, 162 are used. As can be appreciated from the above description, the smaller second diaphragm 138, 162 does not experience a deflection as great as the larger first diaphragm 126, 150, nor does it generate as much force. Similarly, the shorter second brake actuating arm 144, 168 does not convert as large a force as the longer first brake actuating arm 132, 156. The resulting braking force of the second friction device 15 is less than the resulting braking force on the first friction device 13.

Those skilled in the art appreciate that suspensions in tandem axle vehicles may articulate during braking such that one axle takes on more loading while the other axle takes on less loading. The braking distance of the vehicle can be reduced by the present invention by directing additional braking force, using one or more of the methods and/or apparatus described above, to the axle with the additional loading.

In accordance with the provisions of the patent statutes, the present invention has been described in what is considered to represent its preferred embodiments. However, it should be noted that the invention can be practiced otherwise than as specifically illustrated and described without departing from its spirit or scope.

1. A tandem axle system, comprising:
a first axle having a first brake actuating chamber with a first diaphragm, said first diaphragm connected to a first brake actuating arm for engaging a first friction device on said first axle;
a second axle having a second brake actuating chamber with a second diaphragm, said second diaphragm having a smaller area than said first diaphragm, said second diaphragm connected to a second brake actuating arm for engaging a second friction device on said second axle; and
at least one control valve in fluid communication with both said first and said second diaphragms to displace said first and second brake actuating arms and engage said first and second friction devices on said first and said second axles, respectively.

2. The apparatus of claim 1, wherein a displacement of said second brake actuating arm by said second diaphragm is less than a displacement of said first brake actuating arm by said first diaphragm.

3. The apparatus of claim 1, wherein said first and said second brake actuating arms have a substantially equal length.

4. The apparatus of claim 1, wherein said second brake actuating arm is shorter than said first brake actuating arm.

5. The apparatus of claim 1, wherein said at least one control valve provides less fluid pressure to said second brake actuating chamber than said first brake actuating chamber.

6. The apparatus of claim 1, wherein a second control valve is in fluid communication with said second brake actuating chamber, wherein said second control valve provides less fluid pressure to said second brake actuating chamber than fluid pressure provided to said first brake actuating chamber.

7. A tandem axle system, comprising:
a first axle having a first brake actuating chamber having a first diaphragm, said first diaphragm connected to a first brake actuating arm for engaging a first friction device on said first axle;
a second axle having a second brake actuating chamber having a second diaphragm, said second diaphragm connected to a second brake actuating arm, said second brake actuating arm shorter than said first brake actuating arm, for engaging a second function device on said second axle; and
at least one air control valve in communication with both said first and said second diaphragm for individually engaging said first and said second diaphragms to displace said first and second brake actuating arms and engage said first and second friction devices on said first and said second axles, respectively.

8. The apparatus of claim 7, wherein said second diaphragm has a smaller area than said first diaphragm.

9. The apparatus of claim 7, wherein a displacement of said second brake actuating arm by said second diaphragm is less than a displacement of said first brake actuating arm by said first diaphragm.

10. The apparatus of claim 7, wherein said at least one air control valve provides less fluid pressure to said second brake actuating chamber than said first brake actuating chamber.

11. The apparatus of claim 7, wherein a second air control valve is in fluid communication with said second brake actuating chamber, said second air control valve provides less fluid pressure to said second brake actuating chamber than fluid pressure provided to said first air control valve.

12. A method of braking a tandem axle system, comprising:
engaging a first friction device on a first axle with a first brake actuating arm connected to a first diaphragm;
engaging a second friction device on a second axle with a second brake actuating arm connected to a second diaphragm; and
providing a pre-determined amount of pressurized fluid to said first diaphragm and said second diaphragm to engage said first friction device and said second friction device.

13. The method of claim 12, wherein said second brake actuating arm is shorter than said first brake actuating arm.

14. The method of claim 13, wherein said second brake actuating arm provides a braking force to said second friction device less than a braking force said first brake actuating arm provides to said first friction device.

15. The method of claim 13, wherein said second diaphragm has a smaller area than said first diaphragm.

16. The method of claim 15, wherein said second diaphragm displaces said second brake actuating arm a shorter distance than said first diaphragm displaces said first brake actuating arm.

17. The method of claim 12, wherein an control valve provides less fluid pressure to said second brake actuating chamber than said first brake actuating chamber.

18. The method of claim 12, wherein a first control valve provides an equal fluid pressure to said second brake actuating chamber and to said first brake actuating chamber.

19 The method of claim 18, wherein a second control valve in fluid communication with said second brake actuating chamber communicates a fluid pressure to said second brake actuating chamber less than a fluid pressure communicated to said first brake actuating chamber.
